(19) United States
(12) Patent Application Publication
(10) Pub. No.: US 2003/0118968 A1
(43) Pub. Date: Jun. 26, 2003

(54) Dental implant and method to regain interproximal bone and reconstruct the interdental papilla

(76) Inventor: Yehia Aly Massoud, New York, NY (US)

Correspondence Address: YEHIA A. MASSOUD, D.D.S., 140 EAST 56TH ST., #1C, NEW YORK, NY, 10022, US

(21) Appl. No.: 10/022,530

(22) Filed: Dec. 20, 2001

(51) Int. Cl. A61C 8/00

(52) U.S. Cl. 433/173

(57) ABSTRACT

A dental implant and method of its implantation are disclosed. The dental implant provides a platform for attaching a crown. The dental implant and crown provide an aesthetic, natural looking appearance, especially in the interproximal region between the implant and adjacent teeth, at the juncture of the implant and crown, and along the gum line, which generally corresponds to the location of the cementoenamel junction of a healthy natural tooth. The implant and method of the present invention enable regeneration of the interdental papilla to occur, which contributes to the esthetic, natural appearance of the restoration resulting from use of this dental implant and procedure.

### BACKGROUND OF THE INVENTION

The interdental papilla is usually lost following tooth extraction, or is not present in a congenitally missing tooth. If an implant is used to replace the tooth, regeneration of the papilla is a concern. This is especially important for the anterior zone as this presents an esthetic challenge. The anterior zone of the mouth is the area visible from the front when the patient smiles. To date, although a number of techniques have evolved for attempting to regain the interdental papilla, no single technique has evolved predictably as the technique of choice to overcome the many difficulties inherent in this reconstructive procedure. Heretofore, known techniques have failed to take into consideration the morphology required to obtain a predictable, consistent, and stable result.

The objective of restoring the interdental papilla after implant placement and tooth replacement with a crown is to recreate the natural appearance of the tooth and surrounding soft tissues both for medical and esthetic reasons.

In a natural state, the labial (facial) gingival margin follows a scalloped outline along the outer facing surface of the tooth, and rises in the interproximal spaces which are filled in by the gingival interdental papilla. The gingival line follows the curvature of the cervical line of the tooth. The shape of the gingival interdental papilla is governed by the contour of the proximal surfaces of the teeth, the height and shape of the contact area of the teeth, the dimensions of the gingival embrasures and, most notably, the position of the crest of the interproximal bone.

The relationship between the distance from the contact point to the crest of the bone has been studied by one investigator and it has been determined that as the distance increases more than 5 mm, the incidence of papilla regrowth decreases substantially. Others have similarly demonstrated that when the distance from the crest of the bone to the apical extent of the contact point is greater than 5 mm, the predictability of the papillary length diminishes.

In the anterior region, an interdental papilla typically has a triangular shape when viewed frontally, with the apex of the triangle just below the contact point and the base of the triangle towards the apex of the tooth. Moving towards the distal facial surface, facing towards the interior of the mouth, the contact point is positioned in a more apical direction, leading to a lower height of the interdental papilla.

In an anterior tooth, located towards the front of the mouth, the cervical line, which is the line at the juncture of the tooth and gum, and which, for a healthy tooth coincidentally occurs at the demarcation between the generally above-the-gum, enamel, and the generally below-the-gum, cementum, region of the tooth, has a concave shape when viewed labially, that is, towards the upper or lower lip, for an upper or lower tooth, respectively, along the facial surface of the tooth, with the line rising interproximally to a convex shape in the interdental space.

Histologically, the gum tissue which faces the tooth is composed of keratinized oral sulcular epithelium in the coronal portion. Apical to that is the non-keratinized junctional epithelium (JE) which becomes thinner as it approaches the junction of the cementum and enamel regions, also known as the cementoenamel junction (CEJ). The JE attaches to the tooth surface via an internal basal lamina. Apical to the JE is a connective tissue attachment to the cementum of the tooth. The alveolar bone, which is separated from the tooth by way of the periodontal ligament, is further apical to this connective tissue attachment. The JE has an average height of 2 mm and it is separated from the alveolar bone by a connective tissue zone approximately 1 mm high. The height of soft tissue coronal to the alveolar bone margin is thus approximately 3 mm. Since the coronal portion of the connective tissue attachment is directly below the CEJ, and is approximately 1 mm thick, as stated above, the crest of the bone then follows the CEJ in a distance of 1 mm.

The situation of attachment to an implant is somewhat different. In a tooth, dentogingival and dento-alveolar fiber bundles, known as Sharpey's Fibers, project in apical, coronal and lateral directions. These ligaments are missing in a gingival-implant junction. In addition, there is no periodontal ligament separating the bone from the implant. There are collagen fibers, though, which either run in a parallel direction to the implant as opposed to the fibers around a tooth, or insert in the periosteum at the crest of the bone. Coronal to the connective tissue attachment, there is a 2 mm zone of junctional epithelium. The peri-implant mucosa, then, is composed of a 2 mm long JE and approximately a 1 mm connective tissue zone. Therefore, the distance of the alveolar bone margin around an implant to the top of the mucosal/implant attachment is typically on the order of 3 mm.

Endosseous dental implants typically have a flat coronal shape, with the interproximal portion being no higher than the labial. Osseointegration, the healing process of bone fusing to the implant, generally occurs up to the crest of the implant, such that the interproximal bone is not higher than the labial bone. Therefore, the tissue attachment and gingival margin follow the bony contour as dictated by the crestal outline of the implant, resulting in a flat labial marginal gingival profile with no interproximal rise.

Several previous attempts for increasing the interdental gingival height have been made, including the use of free gingival grafts, sliding grafts, and palatal strip grafts. Some clinicians have advocated the use of an overcontoured provisional crown exerting pressure on the gingival in order to stimulated growth. Some have proposed the use of guided soft tissue augmentation to increase the height of the papilla. Others have advocated the use of connective tissue grafts with a tubed pedicle graft. These procedures merely would create a deeper gingival pocked since only the gingival margin, and not the soft tissue attachment and bone, is moving coronally. This may result in restricted access for cleaning and the accumulation of pathogens, resulting in periodontal disease.

One researcher has proposed a technique to maintain the crest of the bone and soft tissue architecture, particularly the papilla. However, even if the interproximal bone is maintained through careful extraction and implant placement, the placement of the implant could only be in one of two alternative positions.

1) wherein, the coronal portion is placed to the crest of the bone in the labial area, leaving the implant submerged below the interproximal bone. This would lead to resorption of the interproximal bone and collapse of the osseous support needed for the papilla: or

2) wherein the implant crest is placed at the crest of the interproximal bone, then the labial portion would be higher than the labial crest of bone by a range of 2 mm to about 4 mm, leaving the threads exposed or nearly exposed in the labial area, which is an undesireable situation.

One researcher has proposed augmenting the interproximal bone with a titanium guide in order to provide the needed osseous support for the papilla. This, however, does not take into account the necessary soft tissue attachment and structure required to maintain such a form since the peri-implant mucosa would not be attaching onto the implant as it is coronal to the crest of the implant. It also does not account for the need to have the bone integrate with the implant in order for there to be the proper dimensions for soft tissue attachment and the gingival margin, the bone is left coronal to the crest of the implant with this technique. Although this procedure has numerous shortcomings, it was the first to address the basic problem of rebuilding and maintaining the papilla, by recognizing that bony support for an implant at the interproximal level must be higher than at the facial level.

In order to rebuild and maintain the bone height and topography required for soft tissue attachment, proper soft tissue outline and profile, and gingival margin formation and definition, the implant on which the bone is integrating and the soft tissue is attaching, needs to follow those same contours as a natural tooth.

Because current dental implant designs have a flat coronal portion, whereas as CEJ is not flat, an implant with a coronal portion shaped like the CEJ of a tooth creates the natural labial profile of the gingival margin as it allows the bone and soft tissues to grow in accordance to that contour.

The advantages of using a dental implant that is shaped more like a natural tooth is that the bone and soft tissue surrounding the implant have a platform which allows them to regrow in a manner that more closely follows the anatomy and outline of the tissues that surround a natural tooth.

Heretofore, all attempts to overcome the aesthetic shortcomings of implant therapy have focused on altering the tissues surrounding the implant, or on the creation of abutments that mold the soft tissue into an aesthetically acceptable profile. There has been no attempt to change the design of the implant on which the soft tissue and bone are supported.

Although the use of dental implants having a scalloped shape is known in the art, it was heretofore not known exactly where the implants should be placed when bone remodeling has occurred after tooth loss. It has been the general practice to place such a scallop-shaped dental implant in a way so that high points of the curves of the scallop-shaped portion of the implant are in the interproximal area between adjacent teeth in order to maintain the height of the bone. In most instances, however, once tooth loss and subsequent bone remodeling have occurred, the crest of the bone at the implant site becomes flat and does not remain scallop-shaped. It is necessary to regenerate the original, natural scalloped shape of the crest of the bone. If a scallop-shaped implant is placed so that the high points are at the crest, then the facial and lingual aspects of the implant are submerged below the height of the bone at those locations. This would lead to resorption of bone at those locations resulting in the need for a longer crown and creation of an unaesthetic appearance. Moreover, in such a case, the crest of bone in the interproximal region would not be regenerated in any case because it would already have been lost when the original tooth at the implant site was extracted and the bone remodeled itself, because interproximal bone is the first to resorb when a tooth is lost or removed. If, instead, a scallop-shaped dental implant were placed so that the facial and lingual surfaces were at the crest of the bone, then the interproximal surfaces would be higher than the crest, and there would be no interproximal bone to maintain. The space between the high point of the implant and the crest of the bone fills in with epithelial and connective tissue, which would obviate the need for an implant to provide for bone growth on the interproximal surfaces so as to support the gingival papilla.

In the normal healing process that follows tooth loss or removal, bone does not remain scallop-shaped for more that 1-2 weeks. Furthermore, the most common cause of tooth loss is periodontal disease. This disease process would already have destroyed bone prior to tooth extraction. Hence, a scallop shaped implant does not have bone to maintain. A scallop-shaped implant has to maintain bone only when it is placed immediately following an extraction of a tooth with intact bone. This, however, is a rare occurrence because intact bone is seldom found around a tooth in need of extraction.

The most practical use of a scallop-shaped implant is not for bone maintenance, but for bone regeneration in order to provide a suitable platform to support a regenerated ideal bone contour, support of the interdental gingival papilla, and a more aesthetic result when the crown portion of the dental implant is installed on the post.

It is known that if an implant is placed higher than the crest of the bone at the implant site and the space between an implant and a tooth, or between two implants, is isolated to prevent ingrowth of connective and epithelial tissue, there is a greater likelihood that osteoblasts from underlying bone would regenerated new bone growth.

If an implant is adjacent to a natural tooth, then the periodontal ligament (PDL) and cementum of the adjacent tooth create new periodontal fibers that attach to the cementum of that tooth resulting in a new periodontal attachment. This periodontal regeneration technique has many applications. The space being isolated can be supported with various means, including, but not limited to, bone grafting materials in the space to promote new bone growth, and to be covered with a resorbable or non-resorbable barrier membrane to prevent the migration of other tissues into the site. Enamel Matrix Proteins (EMP) and Bone Morphogenic Proteins (BMP) can also be applied at the site. Yet another technique is to not use any grafting or osteoconductive materials in the space, and to leave the space empty and supported by a reinforced membrane that will not collapse into the space while bone and PDL are regenerating, as osteoblasts and cementoblasts from underlying bone and adjacent PDL and cementum fill into the space.

One finding that led to the development of the present invention was that a dental implant alone cannot regenerate the bone that is needed in order for the implant to support it. A dental implant needs to be placed together with simultaneous use of a bone regenerating technique in order to regain the bone and the PDL that has been lost following the loss or extraction of a tooth. Only by so doing, can the normal contour for the scallop-shaped bone and support for the interdental papilla be provided.

Accordingly, the objects of the device and method of the present invention are to overcome the limitations and drawbacks of the prior art and make a significant contribution to the state of the art of dental implants by providing a dental implant and a specific method of implanting same wherein the dental implant has the advantages associated with having the shape of a natural tooth at the CEJ, such that the resulting shape and outline of the bone and soft tissue which regenerate to surround the implant provided a natural-looking, aesthetic appearance without causing any compromise of periodontal functionality.

### SUMMARY OF THE INVENTION

The present invention discloses a dental implant device and a method for its implantation at a site where a natural tooth has been lost or extracted. The implant of the present invention provides a platform for attaching a replacement crown in such a way as to provide an aesthetic, natural looking appearance, especially in the interproximal region between the implant and adjacent teeth. This is accomplished by providing for the same scallop-shaped curvature of the juncture of the implant and subsequently attached crown at the gum line, or at the CEJ of adjacent teeth and regenerating the lost bone and soft tissues.

### BRIEF DESCRIPTION OF THE DRAWINGS

FIG. 1 is a general overall frontal view (labial or facial view) of a dental implant according to the present invention.

FIG. 2 is a general overall side view (interproximal view) of a dental implant according to the present invention.

FIG. 3 is a facial view of the dental implant of FIG.1 emplaced with the high points of the interproximal portions of the implant (B) at the crest of bone. The facial and lingual portions (C), being lower than the interproximal, are submerged below the crest of bone.

FIG. 4 is an interproximal view of the dental implant of FIG. 1 emplaced with the high points of the interproximal portions of the implant (B) at the crest of bone. The facial and lingual portions (C), being lower than the interproximal, are submerged below the crest of bone.

FIG. 5 is a facial view of the dental implant of FIG. 1 emplaced with the low point of the facial portion of the implant (C) at the crest of the bone.

FIG. 6 is an interproximal view of the dental implant of FIG. 1 emplaced with the low points of the facial and lingual portion of the implant (C) at the crest of the bone and the high points of the interproximal portions (B) of the implant emplaced above the crest of bone.

FIG. 7 is a view of two dental implants of FIG. 1 emplaced next to a natural tooth with the high points of the interproximal portions of the implant at the same level as the highest point of the CEJ of the adjacent tooth. The low point of the facial surface is at the crest of bone. The adjacent implant is aligned in a similar position.

FIG. 8 is a detailed view of the dental implant of FIG. 1 emplaced at an implant site and showing additional features and elements of the emplaced implant.

### DETAILED DESCRIPTION OF PREFERRED EMBODIMENTS OF THE INVENTION

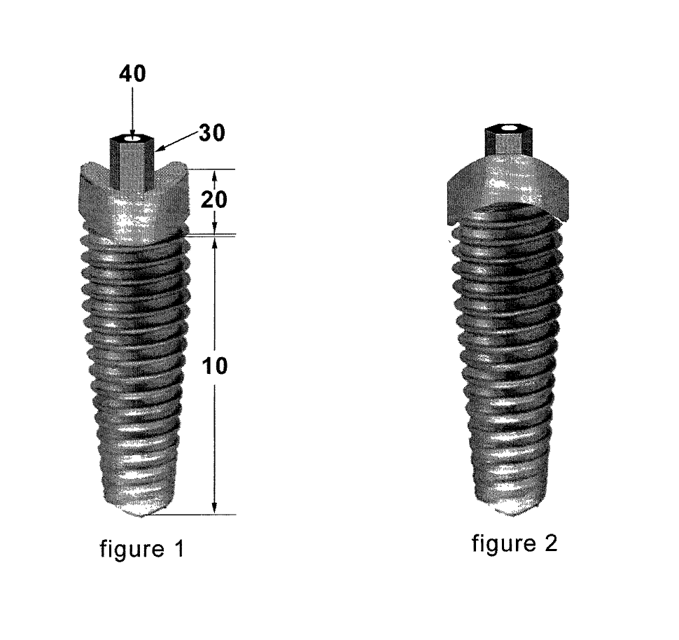

FIGS. 1 and 2 show the dental implant prosthesis according to the present invention is a scallop shaped implant, which serves as a platform for the regeneration and support of interproximal bone, which is higher than facial and lingual bone. The three main parts of the dental implant are the root portion, (FIG. 1, #10) which is made from a biocompatible material, including but not limited to, metal ceramic, glasses or any combination thereof. The preferred material is titanium. The root portion is either threaded or bullet shaped cylindrical, conical or stepped. It is the root part which is designed for anchoring in the bone. It can also be coated with materials that are known in the art to promote osseointegration, such as, but not limited to, hydroxylappatite, titanium plasma spray. The root portion can also be textured to enhance osseointegration with such surface treatment as grit-blasting, acid etching or other means to roughen the bone apposition root portion of the implant.

The collar of the implant (FIG. 1, #20) has a smooth machine polished surface which enhances soft tissue attachment. The collar has a scallop shape. FIG. 1 shows the implant with the facial portion of the implant facing forward. The low point, or valley, in the curve of the collar is the center of the facial portion. The lingual portion is identical and is not shown since it on the opposite side of the implant. The peaks of the curve of the collar correspond to the interproximal portions. The difference in height between facial and interproximal portions can vary from 1 mm to 5 mm, depending on the area of the mouth the implant is being placed.

FIG. 2 shows the present invention with the dental implant from a side (proximal) view rotated 90 degrees, showing the high point of the interproximal surface of the collar at the center and the low points of the facial and lingual portions on either side.

The tooth attachment part (FIG. 1, #30) can be in the form of an external hex, or internal hex, with a screw slot inside (FIG. 1, #40) to allow for attachment of the crown to the implant. Shapes other than hexagons can also be incorporated.

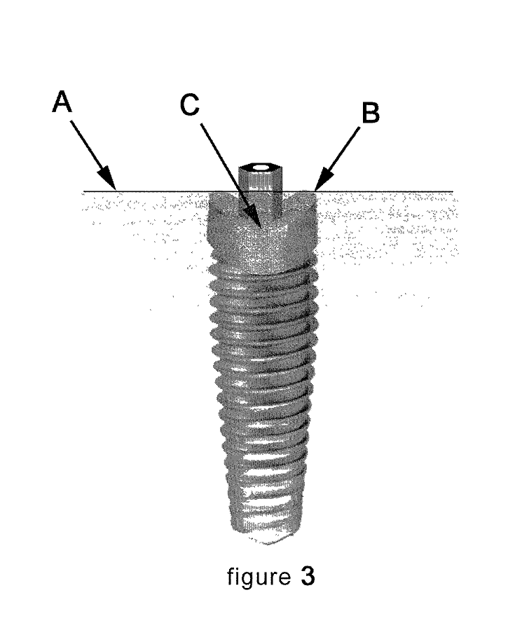

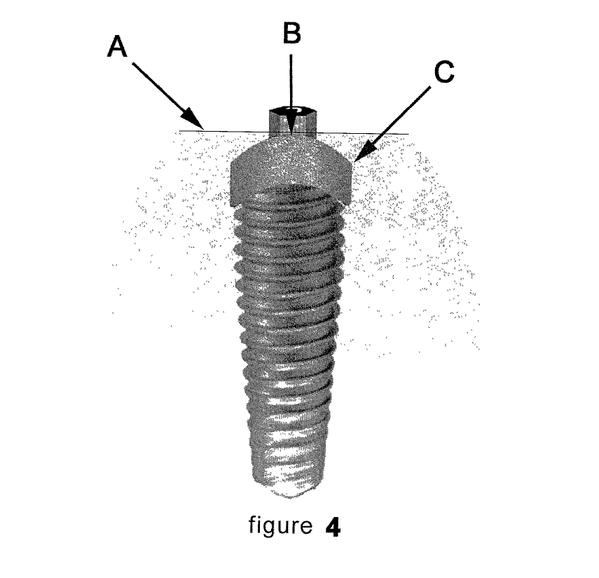

FIGS. 3 and 4 show prior art implant placement in an edentulous area. Since the crest of the bony ridge (FIGS. 3 and 4, A) is usually flat following tooth loss, and the shape of a scalloped implant is curved with the interproximal portions (FIGS. 3 and 4, B) being at a higher level than the facial and lingual portions (FIGS. 3 and 4, C), not all portions of the collar of the implant will contact the crest of bone. If the interproximal portions are placed at the crest of the bone then the facial and lingual portions are submerged below the crest. This would cause resorption of the facial and lingual bone and lead to a longer, unaesthetic crown. Furthermore, there would be no regeneration of the interproximal bone.

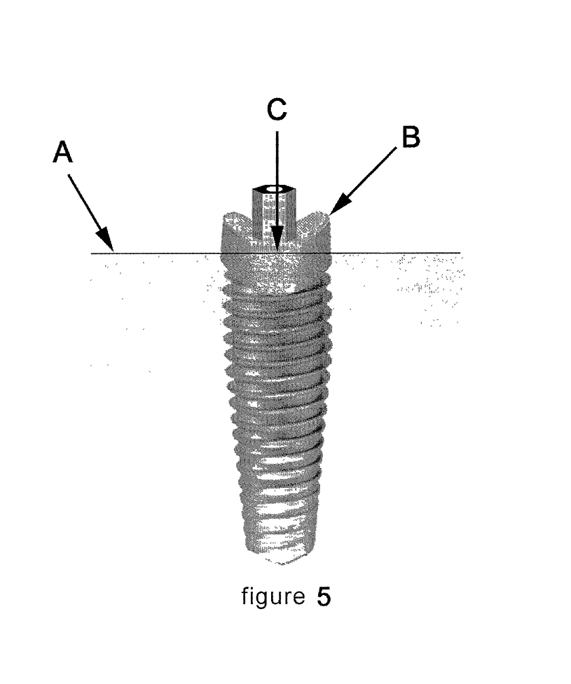

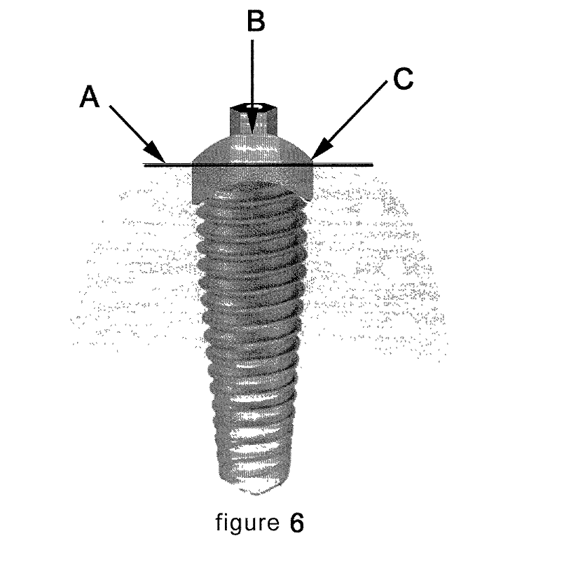

FIGS. 5 and 6 show another position of implantation in prior art. If the facial and lingual portions (FIGS. 5 and 6, C) are placed at the crest of the bone (FIGS. 5 and 6, A) then the interproximal portions (FIGS. 5 and 6, B) are higher than the crest of bone, thus leaving a space between the implant and bone. This would allow ingrowth of other tissues, but would not regenerate the necessary interproximal bone.

Since there is usually insufficient vertical bone to provide the coronal extent required interproximally, as is necessary for adequate papillary support, in such a situation it is necessary to place the implant in a proper vertical height position in relation to the crest of bone (FIGS. 5, 6 and7) and graft bone to achieve the necessary alveolar interproximal height.

The method according to the present invention will first be described for this embodiment.

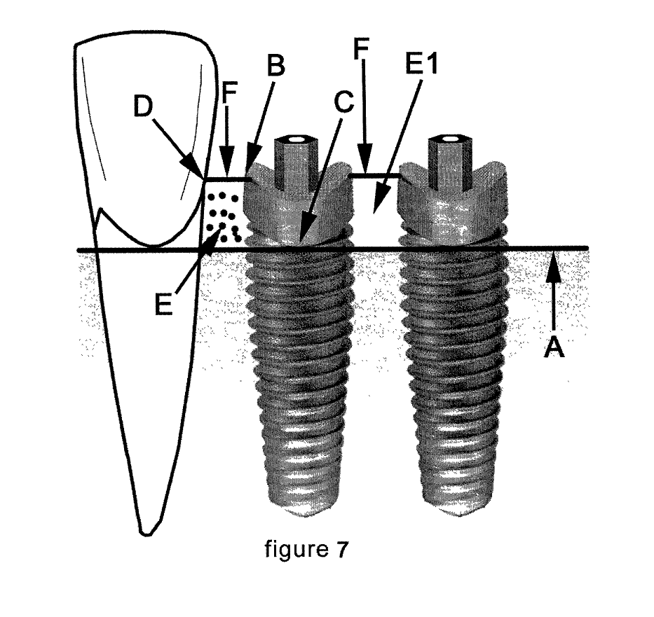

An incision lingually placed to the midcrest is made in the edentulous area extending to the intersulcular space of the adjacent tooth to either side of the implant site. A vertical releasing incision is placed one tooth distal to the edentulous area on either side. A full thickness flap is elevated buccally in order to expose the alveolar crest. An osteotomy is placed in the implant site in the same manner and according to the same parameters as is standard for implant emplacement.

Where a bulltet-shaped implant is utilized, the implant is then placed with its interproximal portion (FIG. 7, B) on the mesial side being at the adjacent CEJ (FIG. 7, D) and the labial and lingual portion (FIG. 7, C) at the crest of bone (FIG. 7, A).

Where a screw implant is utilized, it is screwed into place such that the final turn positions the interproximal portion of the implant at or slightly higher than the adjacent CEJ. FIG. 7 demonstrates this position. This results in what is in effect a horizontal bony defect between the implant and adjacent tooth. This defect is treated by grafting it with an appropriated material such as Bio-Oss, irradiated cancellous and the like.

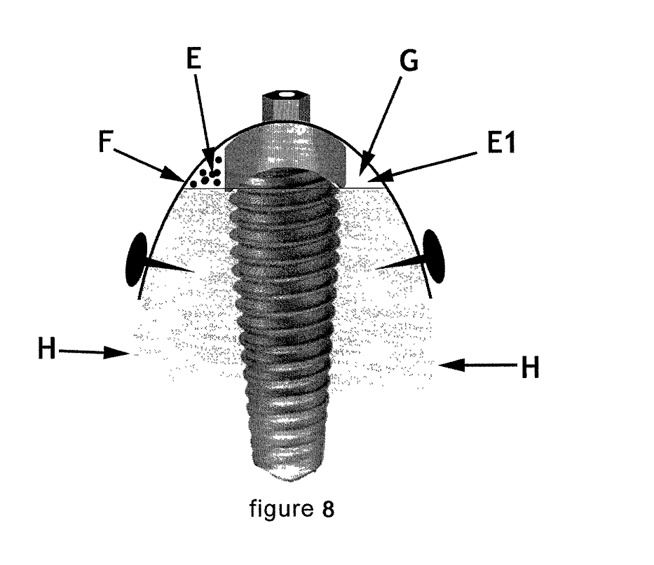

The cementum of the adjacent tooth is then scaled and treated as for periodontal surgery to be followed by placement of the above mentioned graft materials (FIG. 7, E) or the space left empty (FIG. 7, E1). A barrier membrane, either resorbable or non-resorbable, is next placed over the defect and implant coronally and extending both buccally and lingually (FIG. 7, F). The membrane may be held in place with tacks or the cover screw of the implant. FIG. 8 shows a proximal view of the implant that is emplaced with a barrier membrane (FIG. 8, F) covering the implant and the space (FIG. 8, G) which is to have interproximal bone regeneration. This space can be filled with graft materials (FIG. 8, E) or left empty (FIG. 8, E1). The barrier membrane is tacked into place against the buccal and lingual bone (FIG. 8, H). The soft tissue flap is approximated over the implant to provide primary closure, and is then sutured in place. A period of time of from about 4 to about 6 months, sufficient to allow osseointegration of the implant as well as development and maturation of newly formed bone is allowed. Newly formed bone integrates to the implant and attaches to the tooth via the PDL. After the period of osseointegration, the implant is uncovered and any overgrowth of bone on the labial and/or lingual surfaces is carefully removed, taking care not to damage the surface of the implant. The crest of the bone is left from about 0.5 mm to 1 mm apical to the crest of the implant, and following the curve of the implant. This would allow the soft tissue to attach to the coronal 0.5 mm to 1 mm of the implant. A healing abutment or an abutment with a provisional crown is emplaced to shape the gingival during the healing stage. After sufficient soft tissue healing and regrowth has occurred, the final crown is fabricated and fitted.

What is claimed is:

1. A method for emplacing a dental implant for replacing a natural tooth in a mammal, the method comprising the steps of:
a) determining a vertical height of bone at the dental implant site, at which a dental implant is to be emplaced;
b) ascertaining whether the vertical height of bone at the dental implant site is sufficient to support emplacent of a dental implant at the dental implant site;
c) when the vertical height of bone at the dental implant site has been ascertained in (b) to be insufficient to support emplacement of a dental implant at that dental implant site, making an incision palatal to the crest of bone, extending to the intersulcular space of each tooth on either site of the dental implant site, with a vertical releasing incision on either side of the adjacent teeth to the implant site;
d) forming bucally and palataly, elevating a full thickness soft tissue flap in order to expose an alveolar crest of the bone;
e) performing an osteotomy at the dental implant site;
f) selecting a dental implant from the group consisting of a bullet-shaped dental implant and a screw-threaded implant;
g) where, the dental implant selected in (f) is a bullet-shaped dental implant, emplacing the implant in the dental implant site such that an interproximal portion thereof is on a mesial side and extends above the crest of the ridge in the vertical height of bone at the dental implant site (FIGS. 5 and 6), where such extension of the interproximal portion of the dental implant is positioned at the same level of the cementoenamel junction (CEJ) of the adjacent tooth (FIG. 7);
h) where, alternatively, the dental implant selected in (f) is a screw-threaded dental implant, emplacing the implant in the dental implant site such that a final turn of the screw-threaded implant positions the interproximal portions of the dental implant at the same level of the CEJ of the adjacent tooth (FIG. 7)
i) where, multiple dental implants are to be placed side by side, emplacing the implants in the dental implant site with the facial portions of the dental implants at or higher than the crest of bone (FIG. 5) and, the interproximal portions of the dental implants at the same level to the adjacent dental implants higher than the crest of bone (FIGS. 6 and 7);
j) the space between the interproximal portion of the dental implants and the adjacent tooth on either side of the implant is to be filled with bone regeneration graft material (FIG. 7);
k) the entire implant and interproximal areas and bone regeneration graft material are covered with a resorbable or non-resorbable barrier membrane which is to be held in place with tacks of the cover screw of the dental implant (FIG. 8);
l) where it is decided not to use bone regeneration graft material, the space between the interproximal portion of the dental implant and the adjacent tooth on either side of the dental implant is covered by a reinforced barrier membrane to maintain such spaces and held in place by tacks (FIGS. 7 and 8);
m) emplacing a cover screw over the emplaced dental implant;
n) approximating and suturing the full soft tissue flap formed in (d) over the dental implant;
o) allowing a period of time for new bone growth and integration with the implant to occur;
p) uncovering the dental implant by removing the full soft tissue flap sutured thereover in (n);
q) where a non-resorbable barrier membrane was used, removing the membrane and tacks to be followed by removing excess bone growth in any of a facial, lingual, and interproximal regions of the implant, such that the crest of bone having a height apical to and at least as high as a crest of the implant remains;
r) emplacing an element from the group consisting of a healing cap and an abutment with a provisional crown to promote healing and shaping of gingival tissue around the implant;
s) allowing passage of time for sufficient soft tissue healing and growth to occur; and
t) emplacing a final, permanent crown over the dental implant.

2. A dental prosthesis for implantation in a dental implant site of a mammal, the dental prosthesis comprising:
a post (FIGS. 1 and 2), capable of being implanted into bone in an osteotomized void of an extracted or missing tooth, the post having an elongated right circular cylindrical shaped or conical body portion with a proximal end (FIG. 1, #10) that is embedded in the void of the extracted or missing tooth when implanted, an opposite distal end (FIG. 1, #20) that extends above the void when the implant is implanted at the dental implant site, the distal end of the post having a frusto-conical shape, integral with the body portion of the post, and the body portion of the post having a length sufficient that an interproximal portion of the dental implant on a mesial and distal side extends above a crest of a ridge in a vertical height of bone at the dental implant site (FIG. 6) and is at the cementoenamel junction (CEJ) of a tooth adjacent to the dental implant site.

3. The dental prosthesis according to claim 2, wherein the proximal end of the post is screw-threaded for screw insertion of the post into bone.

4. The dental prosthesis according to claim 2, wherein the proximal end of the post is cylindrical.

5. The dental prosthesis according to claim 2, wherein the proximal end of the post has a step-tapered shape.

6. The dental prosthesis according to claim 2, wherein the proximal end of the post has a conical shape.

7. The dental prosthesis according to claim 2, wherein the frusto-conical distal end of the post, known as a collar, has a scalloped shape (FIG. 1, #20).

8. The dental prosthesis, according to claim 2, wherein the collar has a smooth, machine polished surface to allow soft tissue attachment.

9. The dental prosthesis, according to claim 2, wherein the vertical distance between the high points of the collar (interproximal portions) and the low points of the collar (facial and lingual portions) varies, depending on the area of the mouth such implant is to be used.

10. The dental prosthesis according to claim 2, wherein the distal end of the post has a tooth attachment part which is in the shape of an external or internal hexagon (FIG. 1, #30) with a screw slot inside to allow attachment of the crown to the implant (FIG. 1, #40).

11. The dental prosthesis according to claim 2, wherein the tooth attachment part (FIG. 1, #30) can be in a shape other than a hexagon.

12. The dental prosthesis according to claim 2, in which the proximal end of the post has a surface which is coated with hydroxylappatite.

13. The dental prosthesis according to claim 2, in which the proximal end of the post has a surface which is coated with titanium plasma spray.

14. The dental prosthesis according to claim 2, in which the proximal end of the post is coated with a bone receptive coating.

15. The dental prosthesis according to claim 2, in which the proximal end of the post is treated with surface features to promote osseointegration.
